(19) United States
(12) Patent Application Publication
(10) Pub. No.: US 2025/0349248 A1
(43) Pub. Date: Nov. 13, 2025

(54) DISPLAY PIXEL COMPRISING LIGHT-EMITTING SOURCES AND DISPLAY SCREEN HAVING SUCH DISPLAY PIXELS

(71) Applicant: Aledia, Champagnier (FR)

(72) Inventors: Ivan Petkov, Saint Martin D'Heres (FR); Jaehoon Lee, Grenoble (FR)

(73) Assignee: Aledia, Champagnier (FR)

(21) Appl. No.: 19/204,862

(22) Filed: May 12, 2025

(30) Foreign Application Priority Data
May 13, 2024 (FR) FR2404861

(51) Int. Cl. G09G 3/32; G09G 5/02

(52) U.S. Cl. CPC G09G 3/32; G09G 5/024; G09G 2300/0847; G09G 2330/021

(57) ABSTRACT

A display pixel including a first memory configured to store a digital color signal, a command circuit configured to perform write operations and read operations in the first memory, at least one light-emitting source, and a driver circuit configured to drive said light-emitting source based on the stored digital signal, wherein the command circuit is configured to operate as a finite-state machine to perform the write operations and the read operations.

### CROSS REFERENCE TO RELATED APPLICATIONS

This application claims priority to French application number FR2404861, filed May 13, 2024. The contents of this application is incorporated by reference in its entirety.

### TECHNICAL BACKGROUND

The present disclosure concerns a display pixel comprising light-emitting sources, for example light-emitting diodes, and a display screen having such display pixels.

### PRIOR ART

A pixel of an image corresponds to the unit element of the image displayed by a display screen. For the display of color images, the display screen generally comprises, for the display of each pixel of the image, at least three components, also called display sub-pixels, which each emit a light radiation, called image pixel color component substantially in a single color (for example, red, green, and blue). The superposition of the image pixel color components emitted by the three display sub-pixels provides the observer with the colored sensation corresponding to the pixel of the displayed image. In this case, the assembly formed by the three display sub-pixels used for the display of a pixel of an image is called display pixel of the display screen. Each display sub-pixel may comprise a light source, particularly a light-emitting diode.

The display pixels may be distributed in an array, each display pixel being located at the intersection of a row (also called line) and of a column of the array. Electrodes are provided along the rows and the columns to connect each display pixels to control circuits. Generally, each row of display pixels is successively selected by signal transmitted along the row electrodes, and the display pixels of the selected row are programmed to display the desired image pixels by signals transmitted along the column electrodes.

It is known to control a light emitting diode, by pulse-width modulation, also called PWM (English acronym for Pulse Width Modulation). This type of control consists in circulating successive current pulses of constant intensity in the light-emitting diode, the pulses being repeated cyclically, the duty cycle determining the light intensity emitted by the light-emitting diode. Such a control advantageously makes it possible to operate the light-emitting diode at its optimum operating point where the efficiency of the light-emitting diode, equal to the ratio between the light power emitted by the light-emitting diode and the electrical power consumed by the light-emitting diode, is maximum. Moreover, a pulse-width modulation command allows the current density crossing the light-emitting diode to remain constant. This is advantageous since, for some types of light-emitting diodes, the central wavelength of the radiation emitted by the light-emitting diode may vary with the current density crossing the light-emitting diode.

The display phase can comprise one or several display cycles, each display cycle corresponding to a pulse-width modulation. It is desirable to be able to modify how the display phase is carried out after the manufacture of the display pixel.

The light emitting diode can be supplied by a controllable current source. The biasing of the controllable current source can be based on a digital biasing signal stored in a memory of the display pixel. It is desirable to be able to update a new value for the digital biasing after the display pixel is powered on.

### SUMMARY OF THE INVENTION

An object of an embodiment is to provide a display pixel comprising light-emitting diodes and a display screen comprising such display pixels overcoming all or part of the disadvantages of existing display pixels comprising light-emitting diodes and display screens comprising such display pixels.

An embodiment provides a display pixel comprising a first memory configured to store a digital color signal, a command circuit configured to perform write operations and read operations in the first memory, at least one light-emitting source, and a driver circuit configured to drive said light-emitting source based on the stored digital signal. The command circuit is configured to operate as a finite-state machine to perform the write operations and the read operations. This advantageously allows to modify how the display phase is carried out after the manufacture of the display pixel.

According to an embodiment, the display pixel comprises a controllable current source supplying said light-emitting source with a current, and the driver circuit is configured to turn on or off the controllable current source based on the stored digital signal.

By definition, a finite state machine comprises states and the transition from one state to another is achieved when transition conditions are met. According to an embodiment, the finite-state machine comprises at least first, second, third, and fourth states, and the transitions between at least some of the first, second, third, and fourth states are triggered by the values of a first bit and a second bit. Some transitions between the states can advantageously be triggered by using a reduced number of bits. This embodiment specifies the transition conditions between states of the finite state machine. This embodiment therefore also specifies the structure of the finite state machine among all possible finite state machine structures, namely that the finite state machine is a finite state machine for which the transition conditions between states of the finite state machine comprise the values of the first bit and the second bit. The control circuit effects the transition from one state to another when the transition conditions are met.

According to an embodiment, the transitions between at least some of the first, second, third, and fourth states are further triggered by the values of a counter. Some transitions between the states can advantageously be triggered without using an external signal.

According to an embodiment, the display pixel further comprises a second memory configured to store a digital biasing signal, and a third memory configured to store the first bit and the second bit. The finite-state machine can advantageously be operated with a reduced additional memory. According to an embodiment, the controllable current source is configured to provide a current having an intensity that depends on the digital biasing signal. According to an embodiment, the controllable current source is controlled by pulse-width modulation based on the stored digital signal.

According to an embodiment, the command circuit is configured, in the first state, to write new values of the first bit and the second bit in the third memory, is configured, in the second state, to write a new value of the digital biasing signal in the second memory, is configured, in the third state, to write a new value of the digital color signal in the first memory, and is configured, in the fourth state, to read the value of the digital color signal in the first memory for the driver circuit to drive said light-emitting source. This advantageously allows to update a new value for the digital biasing signal after the display pixel is powered on. According to an embodiment, the command circuit is configured to receive new values of the first bit and the second bit and to write said new values in the third memory in the first state when the command circuit is initially powered on or when a changing of the operation mode of the command circuit is required.

According to an embodiment, the display pixel comprises a first conductive pad intended to receive a first binary signal and a second conductive pad intended to receive a second binary signal. The command circuit is configured to write the new values of the first bit and the second bit in the third memory, the new value of the digital biasing signal in the second memory, and the new value of the digital color signal in the first memory based on the second binary signal clocked by the first binary signal.

According to an embodiment, the command circuit is configured to go to the first state from any of the second, third, or fourth states after the detection of a first pattern of the first binary signal simultaneously with a second pattern of the second binary signal. That advantageously allows to implement a reset sequence in which the command circuit goes back to the first state. Moreover, the reset sequence is advantageously implemented by using the first and second signals that are also used to write data in the first, second, and third memories.

According to an embodiment, the first pattern corresponds to the first binary signal remaining at a given logical state.

According to an embodiment, the second pattern corresponds to the second binary signal comprising one rising edge, or two successive rising edges, or one falling edge, or two successive falling edges, or one rising edge followed by one falling edge, or one falling edge followed by one rising edge.

According to an embodiment, the command circuit is configured to update the first bit and the second bit in the third memory, to update successive bits of the digital biasing signal in the second memory, to update successive bits of the digital color signal in the first memory equal to the successive logical states of the second binary signal at only the rising edges, or at only the falling edges, or at the rising and falling edges of the first binary signal.

According to an embodiment, the driver circuit is configured to drive said light-emitting source by pulse-width modulation based of the digital signal and pulses of the first binary signal. Such a control advantageously makes it possible to operate the light-emitting diode at its optimum operating point.

An embodiment also provides a display screen comprising display pixels as previously described arranged in rows and in columns.

An embodiment also provides a method of operating a display pixel comprising a first memory configured to store a digital color signal, a command circuit configured to perform write operations and read operations in the first memory, at least one light-emitting source, and a driver circuit configured to drive said light-emitting source based on the stored digital signal, the command circuit operating as a finite-state machine to perform the write operations and the read operations.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 partially and schematically shows an embodiment of a display screen;

FIG. 2 shows an example of a block diagram of a display pixel of the display screen of FIG. 1;

FIG. 3 shows a block diagram of an example of operation of the display pixel of FIG. 2;

FIG. 4 shows a state diagram of an embodiment of a finite-state machine implemented by the display pixel of FIG. 2;

FIG. 5 shows a block diagram of an embodiment of a storage circuit of the display pixel of FIG. 2;

FIG. 6 shows timing diagrams of signals used by the display pixel of FIG. 2 implementing the finite-state machine of FIG. 4;

FIG. 7 shows timing diagrams of signals used by the display pixel of FIG. 2 illustrating an embodiment of a writing operation of a bit in a memory;

FIG. 8 shows a block diagram of an embodiment of a current source and of a diode driving circuit of the display pixel of FIG. 2; and

FIG. 9, 10 and FIG. 11 show timing diagrams of signals used by the display pixel of FIG. 2 implementing the finite-state machine of FIG. 4.

### DESCRIPTION OF THE EMBODIMENTS

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

Further, a signal which alternates between a first constant state, for example, a low logical state, noted “0”, and a second constant state, for example, a high logical state, noted “1”, is called a “binary signal”. The high and low states of different binary signals of a same electronic circuit may be different. In practice, the binary signals may correspond to voltages or to currents which may not be perfectly constant in the high or low state.

Further, unless indicated otherwise, when it is spoken of a voltage at a conductive pad, the difference between the potential at said conductive pad and a reference potential, for example, the ground, taken as equal to 0 V, is considered.

Further, the “power terminals” of a metal-oxide-semiconductor field-effect transistor, also called MOS transistor, refer to the source and the drain of the MOS transistor.

Unless specified otherwise, the expressions “around”, “approximately”, “substantially” and “in the order of” signify within 10%, and preferably within 5%. Further the expression “substantially constant” means which varies by less than 10% over time with respect to a reference value.

A light-emitting diode is said to be a three-dimensional light-emitting diode when it comprises a three-dimensional semiconductor element of micrometric or nanometric size extending in a preferred direction, for example a microwire or a nanowire, covered with an active area. In particular, a three-dimensional light-emitting diode is said to be of the radial type when its active zone extends at least over the side walls of the three-dimensional semiconductor element.

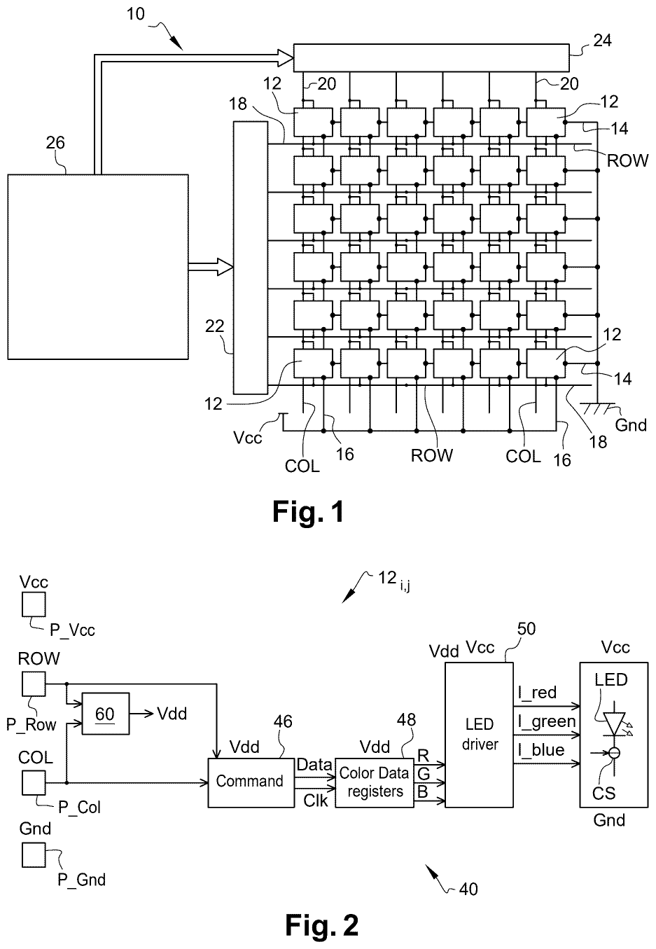

FIG. 1 partially and schematically shows a known example of a display screen 10. Display screen 10 comprises display pixels 12, for example, arranged in M rows and in N columns, M being an integer varying from 1 to 8,000 and N being an integer varying from 1 to 16,000. As an example, in FIG. 1, M and N are equal to 6. Each display pixel 12 is coupled to a source of a low reference potential Gnd, for example, the ground, via an electrode 14 and to a source of a high reference potential Vcc via an electrode 16. As an example, the electrodes 14 are shown as being aligned along the rows in FIG. 1 and the electrodes 16 are shown as being aligned along the columns in FIG. 1, the reverse layout being possible. The power supply voltage of the display screen corresponds to the voltage between high reference potential Vcc and low reference potential Gnd, and is noted Vcc like the high reference potential. Power supply voltage Vcc particularly depends on the arrangement of the light-emitting diodes and on the technology according to which the light-emitting diodes are manufactured. As an example, power supply voltage Vcc may be in the order of from 3.5 V to 5.5 V.

For each row, the display pixels 12 in the row are coupled to a row electrode 18. For each column, the display pixels 12 in the column are coupled to a column electrode 20. The display screen 10 comprises a selection circuit 22 coupled to the row electrodes 18 and adapted to delivering a selection signal ROW on each row electrode 18. The display screen 10 comprises a data delivery circuit 24 coupled to the column electrodes 20 and adapted to delivering a data signal COL on each column electrode 20. The selection circuit 22 and the control circuit 24 are controlled by a circuit 26, for example comprising a microprocessor.

FIG. 2 shows an example of a block diagram of a display pixel 12 of the display screen 10.

The display pixel 12 comprises bonding conductive pads P_Gnd, P_Vcc, P_Col, P_Row. Each conductive pad P_Gnd, P_Vcc, P_Col, P_Row is intended to be coupled to one of the electrodes 14, 16, 18, 20, not shown in FIG. 2. The first conductive pad P_Vcc is coupled, preferably connected, to the electrode 14 and receives the high reference potential Vcc. The second conductive pad P_Gnd is coupled, preferably connected, to the electrode 16 and receives the low reference potential Gnd. The third conductive pad P_Col is coupled, preferably connected, to the column electrode 20 and receives the data signal COL. The fourth conductive pad P_Row is coupled, preferably connected, to the row electrode 18 and receives the selection and timing signal ROW.

For a color display screen, the display pixel 12 comprises a light-emitting circuit 52 comprising at least three light-emitting diodes emitting radiations of different colors, for example red, green, and blue, a single light-emitting diode LED being shown in FIG. 2. In the present example, for each color, the anode of the light-emitting diode LED is for example coupled, preferably connected, to the conductive pad P_Vcc receiving the high reference potential Vcc and the cathode of the light-emitting diode LED is for example coupled, preferably connected, to a terminal of a controllable current source CS, the other terminal of the controllable current source CS being coupled, preferably connected, to the conductive pad P_Gnd receiving the low reference potential Gnd. As a variation, for each light-emitting diode LED, the cathode of the light-emitting diode LED is for example coupled to the conductive pad P_Gnd receiving the low reference potential Gnd and the anode of the light-emitting diode LED is coupled to a terminal of the controllable current source CS, the other terminal of the controllable current source CS being coupled to the conductive pad P_Vcc receiving the high reference potential Vcc.

The display pixel 12 further comprises a driver circuit 40 for driving the controllable current source CS. The driver circuit 40 may particularly comprise electronic components such as MOS transistors or TFTs.

It may be desirable to use at least one decreased power supply voltage Vdd, inferior to supply voltage Vcc, for example lower than 4 V, in particular in the order of 1 V or of 1.8 V, to power at least some of the electronic components of the driver circuit 40, this decreased power supply voltage for example corresponding to the voltage likely to be applied between the power terminals of MOS transistors. For this purpose, the display pixel 12 comprises a supply circuit 60 that supplies the decreased supply voltage Vdd. The supply circuit 60 receives high reference potential Vcc, and at least one of the selection signal ROW and the data signal COL and provides the decreased supply voltage Vdd. As an example, in FIG. 2, the supply circuit 60 is shown receiving the high reference potential Vcc, the selection signal ROW and the data signal COL. As a variation, the display pixel 12 can comprise an additional bonding conductive pad receiving the decreased supply voltage Vdd.

The driver circuit 40 comprises a circuit 46 (Command), also called command circuit 46, coupled to the conductive pad P_Col receiving the data signal COL and coupled to the conductive pad P_Row receiving the selection and timing signal ROW. The command circuit 46 is configured to deliver a clock signal Clk and a data signal Data to a storage circuit 48 (Color Data registers). The storage circuit 48 comprises a memory configured to store digital color signals R, G, B representative of the image pixel. The command circuit 46 is configured to carry out a writing operation in the memory to store the digital color signals R, G, B based on the data signal Data.

The driver circuit 40 also comprise a circuit 50 (LED driver), called diode driving circuit 50 hereafter, for controlling the controllable current source CS associated with each light-emitting diode LED. The command circuit 46 is also configured to carry out a reading operation of the digital color signals R, G, B stored in the storage circuit 48. The diode driving circuit 50 is configured to control the controllable current sources CS coupled to the light-emitting diodes LED with signals I_red, I_green, and I_blue, obtained from the digital color signals R, G, B, to implement a pulse width modulation. The diode driving circuit 50 is supplied with the high reference potential Vcc and the decreased supply voltage Vdd.

As an example, the data signal Data can correspond to the data signal COL and the clock signal Clk can correspond to the selection and timing signal ROW.

As an example, for each color, the controllable current source CS comprises a switch is series with a constant current source providing a constant current having an adjustable intensity. The intensity of the constant current source can be controlled based on a digital biasing signal DBias. The same digital biasing signal DBias can be used for each color. The switch can be turned on or off based on the signals I_red, I_green, and I_blue. As an example, the storage circuit 48 can also comprise a memory for storing the digital biasing signal DBias.

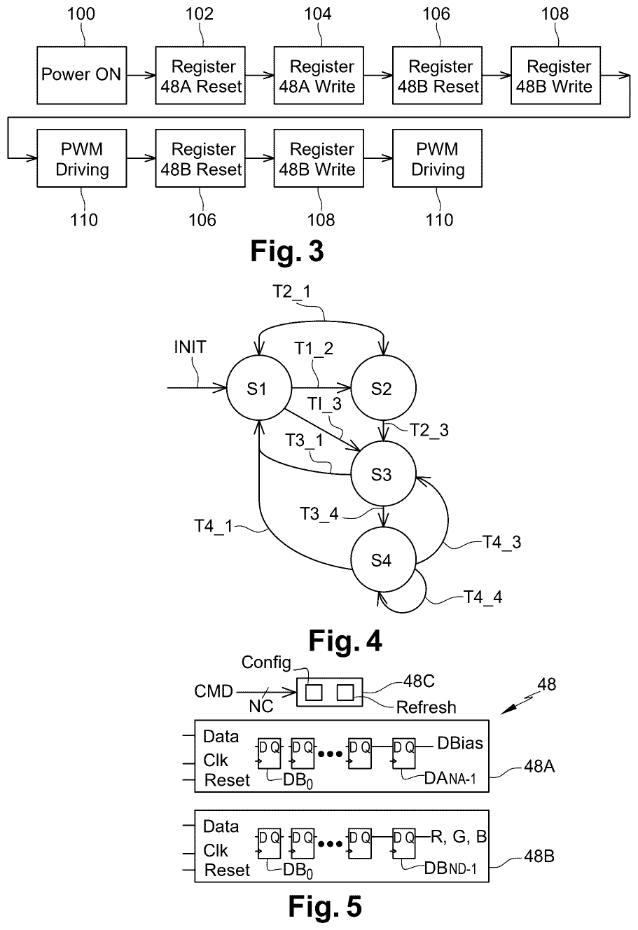

FIG. 3 is a block diagram illustrating an example of method of operation of the driver circuit 40 of the display pixel 12 of FIG. 2.

The operation comprises the following steps:
the display pixel 12 is powered on (step 100);
the memory of the storage circuit 48 in which the digital biasing signal DBias is stored is reset (step 102);
a new value of the digital biasing signal DBias is written in the storage circuit 48 (step 104);
the memory of the storage circuit 48 in which the digital color signals R, G, B are stored is reset (step 106);
new values of the digital color signal R, G, and B are written in the storage circuit 48 (step 108); and
for each color, the light-emitting diode LED is controlled based on the digital color data signal R, G, or B stored in the storage circuit 48 (step 110).

Steps 106, 108, and 110 are repeated each time a new digital color signal R, G, and B is to be displayed, a repetition being shown by way of example in FIG. 3.

A drawback of the method of operation previously disclosed is that the succession of steps cannot be modified once the driver circuit 40 is manufactured. In particular, at step 110, the display phase of an image pixel can comprise two or more display cycles and the number of display cycles cannot be modified once the driver circuit 40 is manufactured. A drawback of the method of operation previously disclosed is that the storage of a new value of the digital biasing signal DBias in the storage circuit 48 requires to switch off the display pixel 12 and switch it on again to begin the method of operation from the first step 100.

According to an embodiment, the command circuit 46 operates as a state machine that allows to control the storage circuit 48 and the diode driving circuit 50 with more flexibility.

FIG. 4 shows a state diagram of an embodiment of the finite-state machine implemented by the command circuit 46 and FIG. 5 shows a block diagram of an embodiment of the storage circuit 48 on which operates the command circuit 46.

In FIG. 4, each state of the finite-state machine is shown by a circle. The possible transitions from one state to another state (or to the same state) is shown by an arrow. According to an embodiment, the finite-state machine comprises four states, called S1, S2, S3, and S4. When the pixel 12 is powered on, the starting state of the finite-state machine is state S1, which is shown in FIG. 4 by the arrow INIT.

As shown in FIG. 5, the storage circuit 48 comprises at least three memories 48A, 48B, and 48C, also called registers 48A, 48B, and 48C. As an example, the digital biasing signal DBias is stored in the register 48A and the digital color signals R, G, B are stored in the register 48B.

The register 48A comprises memory cells DA₀ to DA_{NA-1}. Each memory cell DAK, k being in the range from 0 to NA-1, is configured to store one bit of the digital biasing signal DBias. According to an embodiment, each memory cell DAₖ corresponds to a flip-flop, for example a D flip-flop having an input D and an output Q, and clocked by the clock signal Clk. For each memory cell DAₖ, k being in the range from 0 to NA-2, the output Q of the memory cell DAₗ is connected to the input D of the memory cell DAᵢ₊₁. The output Q of memory cell DA_{NA-1} provides the bits of the digital signal DBias.

The register 48B comprises memory cells DB₀ to DB_{ND-1}. According to an embodiment, each digital color signal R, G, B is coded on a number NB of bits and the number ND is equal to three times the number NB. According to another embodiment, the storage circuit 48 comprises a separate register 48B for storing each digital color signal R, G, B and the number ND is then equal to the number NB. Each memory cell DBₖ, k being in the range from 0 to ND-1, is configured to store one bit of the digital color signals R, G, and/or B. According to an embodiment, each memory cell DBₖ corresponds to a flip-flop, for example a D flip-flop having an input D and an output Q, and clocked by the clock signal Clk. For each memory cell DBₖ, k being in the range from 0 to ND-2, the output Q of the memory cell DBₖ is connected to input D of memory cell DBₖ₊₁. The output Q of the memory cell DB_{ND-1} provides the bits of the color digital signals R, G, or B.

According to an embodiment, a digital signal, called command signal CMD, is stored in the register 48C. The number of bits of the command signal CMD is equal to NC. According to an embodiment, NC is equal to 2. The command signal CMD comprises at least 2 bits called bit Config and bit Refresh.

The inputs that trigger a transition is the value of the bit Config, the value of the bit Refresh, the value of a counter called Count, and a specific pattern of the signals ROW and COL, the pattern being called a reset sequence.

From the state S1, there are one transition T1_2 to the state S2 and one transition T1_3 to the state S3. The transition T1_2 is triggered when the bit Config is at logical value “1” and the counter Count is at the value NC, independently of the value of the bit Refresh.

The transition T1_3 is triggered when the bit Config is set at logical value “0” and the counter Count is at the value NC, independently of the value of the bit Refresh.

From the state S2, there are one transition T2_1 to the state S1 and one transition T2_3 to the state S3. The transition T2_1 is triggered when the reset sequence is carried out. The transition T2_3 is triggered when the counter Count is equal to NA.

From the state S3, there are one transition T3_1 to the state S1 and one transition T3_4 to the state S4. The transition T3_1 is triggered when the sequence Reset is carried out. The transition T3_4 is triggered when the counter Count is equal to ND.

From the state S4, there are one transition T4_1 to the state S1, one transition T4_3 to the state S3 and one transition T4_4 to the state S4. The transition T4_1 is triggered when the sequence Reset is carried out. The transition T4_3 is triggered when the bit Refresh is at logical value “0” and when the counter Count is equal to P. The transition T4_4 is triggered when the bit Refresh is at logical value “1” and when the counter Count is equal to P.

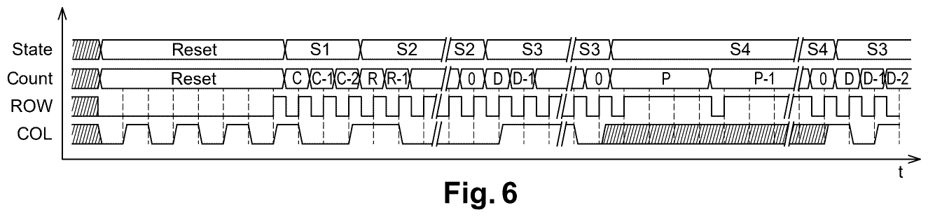

FIG. 6 shows examples of timing diagrams of counter Count and the signals ROW and COL used by the display pixel 12 of FIG. 2 implementing the finite-state machine of FIG. 4. FIG. 6 also shows the current state of the finite-state machine in which the command circuit 46 operates. In the example shown in FIG. 6, the finite-state machine is successively in the state S1, S2, S3, S4, and S3.

In the state S1, the command circuit 46 commands the writing of a new value for the command signal CMD in the register 48C of the storage circuit 48, including new values for the bits Config and Refresh. According to an embodiment, a new value for the command signal CMD is sent to the command circuit 46 to be written in the memory 48C when the command circuit 46 is initially powered on or when a changing of the operation mode of the command circuit 46 is required. According to an embodiment, the writing operation in the state S1 comprises the following steps:
setting the counter Count at the value NC;
resetting the register 48C, by example by setting each memory cell of the register 48 C at logical value “1”;
providing successively each bit of the new value for the command signal CMD to the register 48C;
for each bit of the new value for the command signal CMD provided to the register 48C, decreasing the counter Count by one; and
when the counter Count is equal to 0, setting the counter Count to the value NC.

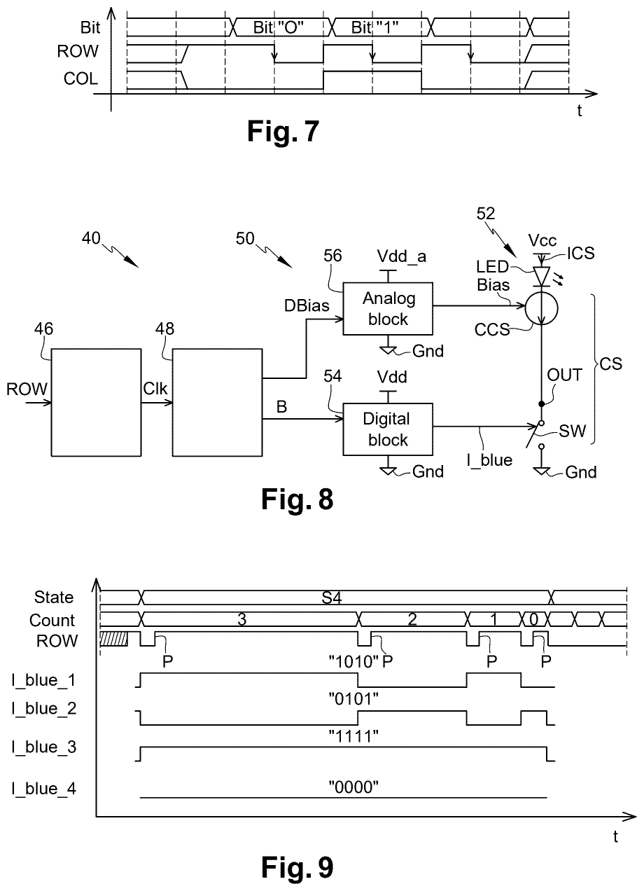

FIG. 7 shows timing diagrams of signals ROW and COL illustrating an embodiment of a writing operation of a bit in the registers 48A, 48B, or 48C of the storage circuit 48. In FIG. 7, signal Bit illustrates the value of the bit that is stored in a memory cell of the registers 48A, 48B, or 48C. According to an embodiment, a write operation is carried out at a falling edge of the signal ROW. This means that the value of the signal COL is sampled at a falling edge of the signal ROW and stored in in a memory cell of the registers 48A, 48B, or 48C. As a variation, write or read operations can be carried out at a rising edge of the signal ROW.

In the state S2, the command circuit 46 commands the writing of a new value for the digital biasing signal DBias in the register 48A of the storage circuit 48. According to an embodiment, the writing operation in the state S2 comprises the following steps:
setting the counter Count at the value NA;
resetting the register 48A, by example by setting each memory cell DA₀ to DA_{NA-1} of the register 48A at logical value “1”;
providing successively each bit of the new value for the digital biasing signal DBias to the register 48A;
for each bit of the new value for the digital biasing signal DBias provided to the register 48A, decreasing the counter Count by one; and
when the counter Count is equal to 0, setting the counter Count to the value NA.

During a writing phase in the state S2, the memory cell DAᵢ, i being in the range from 0 to NA-1, are clocked by signal Clk. The signal Data corresponds to the signal COL that comprises the bits of the digital biasing signal DBias that are provided successively, for example from the most significant bit to the least significant bit, and that move through the succession of memory cells DAᵢ, so that, at the end of the writing phase, the most significant bit of the digital biasing signal DBias stored in memory cell DA_{NA-1} and the least significant bit of the digital biasing signal DBias is stored in memory cell DA₀.

In the state S3, the command circuit 46 commands the writing of new values for the digital color signals R, G, B in the register 48B of the storage circuit 48. According to an embodiment, the writing operation in the state S3 comprises the following steps:
setting the counter Count at the value ND;
resetting the register 48B, by example by setting each memory cell DB₀ to DB_{ND-1} of the register 48B at logical value “1”;
providing successively each bit of the new value for the digital color signals R, G, B to the register 48B;
for each bit of the new value for the digital color signals R, G, B provided to the register 48B, decreasing the counter Count by one; and
when the counter Count is equal to 0, setting the counter Count to the value ND.

According to an embodiment, the digital color signals R, G, and B are stored in a single register 48B. During a writing phase in the state S3, the memory cell DBᵢ, i being in the range from 0 to ND-1, are clocked by signal Clk. The signal Data corresponds to the signal COL that comprises the bits of the digital color signals R, G, and B that are provided successively, for each digital color signal R, G, and B, from the most significant bit to the least significant bit, and that move through the succession of memory cells DBᵢ. As an example, the bits of the digital color signal R are provided first, then the bits of the digital color signal G, and eventually the bits of the digital color signal B, so that, at the end of the writing phase, the most significant bit of the digital color signal R is stored in memory cell DB_{ND-1} and the least significant bit of the digital color signal B is stored in memory cell DB₀. However, the order of the digital color signals R, G, B stored in the register 48B can be different. According to another embodiment, the digital color signals R, G, and B are stored in a separate registers 48B. During a writing phase in the state S3, the signal Data corresponds to the signal COL that comprises the bits of the digital color signal R that are provided to a first register 48B, then the bits of the digital color signal G that are provided to a second register 48B, and eventually the bits of the digital color signal B that are provided to a third register 48B. However, the bits of the digital color signals R, G, B can be provided in a different order.

In the state S4, a display phase is carried out based on the signal ROW, on the digital color signals R, G, B stored in the register 48B of the storage circuit 48, and on the digital biasing signal DBias stored in the register 48A of the storage circuit 48. According to an embodiment, for each color, the controllable current sources CS supplying the light emitting diode LED is controlled by the diode driving circuit 50 by pulse-width modulation.

FIG. 8 shows a block diagram of an example of the controllable current sources CS and of the diode driving circuit 50 of the driver circuit 40 of the display pixel 12 of FIG. 2 for one color, for example blue.

The controllable current source CS comprises a switch SW in series with an adjustable current source CCS providing a current ICS having a controllable intensity. The switch SW can be coupled between a terminal OUT and the conductive pad of the display pixel 12 that is connected to the source of the low reference voltage Gnd. The adjustable current source CCS can be coupled between the terminal OUT and the cathode of the light-emitting diode LED. The switch SW is controlled by the signal I_blue. The adjustable current source CCS is controlled by a constant biasing signal Bias. As an example, the switch SW corresponds to a MOS transistor, for example a N-MOS transistor. The signal I_blue can then correspond to the voltage controlling the gate of the MOS transistor. As an example, the adjustable current source CCS corresponds to a MOS transistor, for example a N-MOS transistor. The biasing signal Bias can then correspond to the gate-source voltage of the MOS transistor.

The diode driving circuit 50 comprises a digital circuit 54 (Digital block) and an analog circuit 56 (Analog block). The analog circuit 56 receives the signal DBias provided by the storage circuit 48. The digital circuit 54 receives the signal B provided by the storage circuit 48 during a read operation clocked by the signal Clk provided by the command circuit 46. The digital circuit 54 provides the signal I_blue to the switch SW. The analog circuit 56 provides the signal Bias based on a digital to analog conversion of the digital biasing signal DBias. The digital circuit 54 can be supplied by the reduced power voltage Vdd that is inferior to the power supply Vcc. The analog circuit 56 can be supplied by another reduced power voltage Vdd_a that can be inferior to the power voltage Vcc. The analog circuit 56 can comprise a digital-to-analog converter providing the signal Bias from the digital biasing signal DBias. When the adjustable current source CCS corresponds to a MOS transistor, the analog circuit 56 provides the signal Bias so that MOS transistor CCS is operated under saturation region.

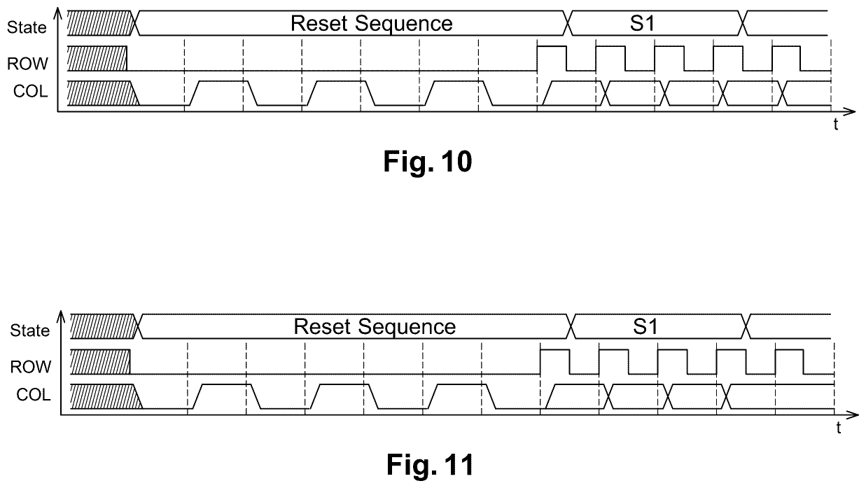

FIG. 9 shows timing diagrams of the signal ROW, the counter Count, and signals I_blue_1, I_blue_2, I_blue_3, and I_blue_4 corresponding to the signal I_blue provided by the diode driving circuit 50 of the display pixel 12 of FIG. 2 for the display of four different digital color signals B. FIG. 9 also shows the current state of the finite-state machine in which the command circuit 46 operates.

According to an embodiment, the light-emitting diodes LED of the display pixel 12 are controlled by pulse-width modulation. For this purpose, during a display cycle, the signal ROW exhibits a succession of pulses P at logical state “1” which rates the reading operation of the register 48B of the storage circuit 48 for the control of the light-emitting diode LED by pulse-width modulation

For each color, in a display cycle, the number of pulses in the succession of pulses corresponds to the number NB+1 of bits of each digital color signal R, G, and B. As an example, the switch SW is closed or open, at the rate of the pulses of the signal ROW, according to the logical value “0” or “1” of each bit of the color signal R, G, or B, for example starting from the most significant bit, this switch SW being maintained closed or open until the next pulse of the signal ROW. In FIG. 9, each pulse P of the signal ROW corresponds to the signal ROW being at the low logical value “0”. Therefore, the controllable current source CS is switched on or off during NB successive durations according to the logical values of the bits of digital color signal R, G, or B. For example, the current source CS can be switched on during a duration when the bit of the color digital data R, G, or B associated with this time interval is at logical value “1” and can be switched off during a duration when the bit of the color digital data R, G, or B associated with this time interval is at logical value “0”.

During a display cycle, the duration between two successive pulses P of the signal ROW is divided each time by two, so that the total duration for which the light-emitting diode LED is on depends on the value of the color signal R, G, or B. The display phase of an image pixel can comprise two or more display cycles. That is to say the succession of pulses P of the signal ROW shown in FIG. 9 can be repeated until the display of another image pixel.

In FIG. 9, as an example, the number NB is equal to 4 and only one display cycle is shown. The signal I_blue_1 is obtained for the display of an image pixel color component corresponding to the color signal B equal to “1010”. The signal I_blue_2 is obtained for the display of an image pixel color component corresponding to the color signal B equal to “0101”. The signal I_blue_3 is obtained for the display of an image pixel color component corresponding to the color signal B equal to “1111”. The signal I_blue_4 is obtained for the display of an image pixel color component corresponding to the color signal B equal to “0000”.

According to an embodiment, called field sequential display, only the signal provided at the output Q of the memory cell DB_{ND-1} of the register 48B is used to provide the bits of the digital color signals R, G, and B. In the state S4, during the display phase, the memory cells DBᵢ, i being in the range from 0 to ND-1, are clocked by the signal ROW. Therefore, the output Q of the memory cell DB_{ND-1} of the register 48B provides successively each bit of the digital color signal R, then each bit of the digital color signal G and then each bit of the digital color signal B from the most significant bit to the least significant bit for each digital color signal R, G and B. The signal ROW comprises at least three display cycles, the first display cycle being used to display the digital color signal R, the second display cycle being used to display the digital color signal G, and the third display cycle being used to display the digital color signal B.

According to another embodiment, called simultaneous display, the output Q of the memory cell DB_{NB-1} of the register 48B is used to provide the bits of the digital color signal B, the output Q of the memory cell DB_{2NB-1} of the register 48B is used to provide the bits of the digital color signal G, and the output Q of the memory cell DB_{ND-1} of the register 48B is used to provide the bits of the digital color signal R. In the state S4, during the display phase, the memory cells DBᵢ, i being in the range from 0 to NB-1, of each register 48B are clocked by the signal ROW. Therefore, the output Q of the memory cell DB_{NB-1} of the register 48B provides successively each bit of the digital color signal B, the output Q of the memory cell DB_{2NB-1} of the register 48B provides successively each bit of the digital color signal G, and the output Q of the memory cell DB_{ND-1} of the register 48B provides successively each bit of the digital color signal R. The digital color signals R, G, B can then be displayed simultaneously.

The display phase of an image pixel can comprise two or more display cycles. The number of display cycles in the display phase is called NY. The number NY is equal or superior to 1. For each color, the total number of the pulses of the signal ROW in a display phase is equal to NY*(NB+1) where NB is the number of bits for each digital color signal R, G, or B.

According to an embodiment, the display cycle in the state S4 comprises the following steps:
setting the counter Count at the value NP;
controlling the register 48B to provide successively each bit of the digital color signals R, G, B clocked by the signal Clk;
for each bit of the new value for the digital color signals R, G, B provided by the register 48B, decreasing the counter Count by one; and
when the counter Count is equal to 0, setting the counter Count to the value NP.

At the end on a display phase, the command circuit 46 repeats a new display phase if the bit Refresh is equal to logical value “1”, which means that the finite-state machine remains in the state S4. In that case, a reset sequence is to be performed to leave the state S4. At the end on a display phase, the command circuit 46 write a new value of the digital color signals R, G, or B if the bit Refresh is equal to logical value “0”, which means that the finite-state machine goes to the state S3.

According to an embodiment, all transitions towards the state S1 when a reset sequence occurs, that is to say when a first pattern of the signal ROW and a second pattern of the signal COL occur simultaneously. According to an embodiment of the first pattern, the signal ROW remains constant, at high logical level “1” or at low logical level “0”. According to an embodiment of the second pattern, the second pattern corresponds to the signal COL having at least two rising edges, or at least two falling edges.

FIG. 10 and FIG. 11 shows timing diagrams of the signals ROW and COL used by the display pixel 12 of FIG. 2 implementing the finite-state machine of FIG. 4 for two embodiments of the reset sequence. For both embodiments shown in FIG. 10 and FIG. 11, for the reset sequence, the signal ROW remains at low logical level “0” and the determined number of pulses for the signal COL is equal to 3. In the embodiment shown in FIG. 10, the detection of the reset sequence and the beginning of the state S1 occurs at the first falling edge of the signal ROW following the determined number of pulses of the signal COL. In the embodiment shown in FIG. 11, the detection of the reset sequence and the beginning of the state S1 occurs at the falling edge of the signal COL at the end of last pulse of the determined number of pulses.

Various embodiments and variants have been described. Those skilled in the art will understand that certain features of these various embodiments and variants may be combined, and other variants will occur to those skilled in the art.

Finally, the practical implementation of the described embodiments and variations is within the abilities of those skilled in the art based on the functional indications given hereabove.

1. A display pixel comprising a first memory configured to store a digital color signal, a command circuit configured to perform write operations and read operations in the first memory, at least one light-emitting source, and a driver circuit configured to drive said light-emitting source based on the stored digital signal, wherein the command circuit is configured to operate as a finite-state machine to perform the write operations and the read operations.

2. The display pixel according to claim 1, comprising a controllable current source supplying said light-emitting source with a current, and wherein the driver circuit is configured to turn on or off the controllable current source based on the stored digital signal.

3. The display pixel according to claim 1, wherein the finite-state machine comprises at least first, second, third, and fourth states, and wherein the transitions between at least some of the first, second, third, and fourth states are triggered by the values of a first bit and a second bit.

4. The display pixel according to claim 3, wherein the transitions between at least some of the first, second, third, and fourth states are further triggered by the values of a counter.

5. The display pixel according to claim 3, further comprising a second memory configured to store a digital biasing signal, and a third memory configured to store the first bit and the second bit.

6. The display pixel according to claim 5, wherein the command circuit is configured, in the first state, to write new values of the first bit and the second bit in the third memory, is configured, in the second state, to write a new value of the digital biasing signal in the second memory, is configured, in the third state, to write a new value of the digital color signal in the first memory, and is configured, in the fourth state, to read the value of the digital color signal in the first memory for the driver circuit to drive said light-emitting source.

7. The display pixel according to claim 6, wherein the command circuit is configured to receive new values of the first bit and the second bit and to write said new values in the third memory in the first state when the command circuit is initially powered on or when a changing of the operation mode of the command circuit is required.

8. The display pixel according to claim 5, comprising a first conductive pad intended to receive a first binary signal and a second conductive pad intended to receive a second binary signal, wherein the command circuit is configured to write the new values of the first bit and the second bit in the third memory, the new value of the digital biasing signal in the second memory, and the new value of the digital color signal in the first memory based on the second binary signal clocked by the first binary signal.

9. The display pixel according to claim 3, wherein the command circuit is configured to go to the first state from any of the second, third, or fourth states after the detection of a first pattern of the first binary signal simultaneously with a second pattern of the second binary signal.

10. The display pixel of claim 9, wherein the first pattern corresponds to the first binary signal remaining at a given logical state.

11. The display pixel of claim 9, wherein the second pattern corresponds to the second binary signal comprising one rising edge, or two successive rising edges, or one falling edge, or two successive falling edges, or one rising edge followed by one falling edge, or one falling edge followed by one rising edge.

12. The display pixel of claim 8, wherein the command circuit is configured to update the first bit and the second bit in the third memory, to update successive bits of the digital biasing signal in the second memory, to update successive bits of the digital color signal in the first memory equal to the successive logical states of the second binary signal at only the rising edges, or at only the falling edges, or at the rising and falling edges of the first binary signal.

13. The display pixel of claim 8, wherein the driver circuit is configured to drive said light-emitting source by pulse-width modulation based of the digital signal and pulses of the first binary signal.

14. A display screen comprising display pixels according to claim 1 arranged in rows and in columns.

15. A method of operating a display pixel comprising a first memory configured to store a digital color signal, a command circuit configured to perform write operations and read operations in the first memory, at least one light-emitting source, and a driver circuit configured to drive said light-emitting source based on the stored digital signal, wherein the command circuit operates as a finite-state machine to perform the write operations and the read operations.
